(19) United States
(12) Patent Application Publication
(10) Pub. No.: US 2017/0170946 A1
(43) Pub. Date: Jun. 15, 2017

(54) SELECTIVE PARTICIPATION ON FULL-DUPLEX COMMUNICATIONS

(71) Applicant: Intel Corporation, Santa Clara, CA (US)

(72) Inventors: Alexander W. MIN, Portland, OR (US); Minyoung PARK, Portland, OR (US)

(21) Appl. No.: 14/969,322

(22) Filed: Dec. 15, 2015

(51) Int. Cl. H04L 5/14; H04B 1/48; H04L 5/16

(52) U.S. Cl. CPC H04L 5/1438; H04L 5/16; H04B 1/48; H04B 2001/485

(57) ABSTRACT

Full-duplex communications may incur some inefficiency in spectrum use for many reasons, including traffic asymmetry (e.g., different data sizes for uplink and downlink transmissions), throughput degradation (due to imperfect self-interference cancellation capability), etc. In certain cases, full-duplex communications can be less attractive and efficient, and even underperform the legacy half-duplex communications, for certain communication scenarios. Therefore, full-duplex-capable nodes (e.g., 802.11 AP and STA) should be able to evaluate performance trade-offs between full-duplex and half-duplex operations and be able to dynamically switch between full-duplex and half-duplex modes, instead of statically using full-duplex (or half-duplex) all the time.

### TECHNICAL FIELD

An exemplary embodiment is directed toward wireless networks. Some embodiments relate to wireless networks that operate in accordance with one of the Institute of Electrical and Electronics Engineers (IEEE) 802.11 standards including the IEEE 802.11-WLAN standards. Some embodiments relate to a wireless network communicating using Wireless Local Area Networks (WLAN). Exemplary embodiments also relate to the communication of two or more stations using full-duplex communications.

### BACKGROUND

The growth and use of electronic devices, such as Internet of Things (IoT) devices and personal communications/entertainment device, are rapidly depleting the available spectrum. To compensate, industry, academia, and even standards bodies, such as IEEE 802.11 WLAN, have focused on developing new communication mechanisms to address spectrum scarcity. One such technology is full-duplex (FD) communications. Full-duplex communications enable a wireless device to send and receive packets at the same time and on the same frequency band (or channel). Full-duplex communication can significantly improve spectrum efficiency by allowing wireless radios to simultaneously transmit and receive data using self-interference cancellation (SIC) technologies in antenna, analog RF circuitry and in digital signal processing.

Despite the implementation of full-duplex communications, issues exist that remain to be resolved. For example, the current full-duplex implementation requires a new MAC design which can involve additional overhead for operations including opportunity identification and link setup. In opportunity identification, overhead is incurred as the access point (AP) searches for a station (STA) for uplink transmission. In link setup, overhead is incurred as additional control data packet exchange may be necessary to share relevant information and to establish the communication between the AP and the STAs. As another example, the full-duplex throughput may underperform half-duplex throughput. This scenario is possible in instances where the actual data transmission duration is not significantly longer than the time spent for full-duplex opportunity detection and link setup. In yet another example, a system enabled for full-duplex communications is always on regardless of the actual performance benefit. Therefore, regardless of the system performance, the AP continues to search for a STA and link setup costs increase in packet transmission. Therefore, it is with these and other considerations that the present improvements have been developed.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary communication environment including one or more access points and one or more stations;

FIG. 2 illustrates the components of an exemplary station (STA);

FIG. 3 illustrates the components of an exemplary access point (AP);

FIGS. 4(a) and 4(b) illustrate an exemplary two-node communications scenarios;

FIG. 5 is a chart illustrating exemplary throughput comparison; and

FIG. 6 is a flowchart illustrating an exemplary method for selective full-duplex communications.

### DESCRIPTION OF EMBODIMENTS

Embodiments may be implemented as part of one or more of: IEEE 802.11, IEEE 802.11 WLAN and/or the Wi-Fi Alliance® Technical Committee Hotspot 2.0 Technical Task Group Hotspot 2.0 (Release 2) Technical Specification, Version 2.04, Jan. 2, 2013. However, the embodiments are not limited to IEEE 802.11 standards or Hotspot 2.0 standards. Embodiments can be used in implementation with other wireless communications standards, protocols, and the like.

In the following detailed description, numerous specific details are set forth in order to provide a thorough understanding of the disclosed techniques. However, it will be understood by those skilled in the art that the present embodiments may be practiced without these specific details. In other instances, well-known methods, procedures, components and circuits have not been described in detail so as not to obscure the present disclosure.

Presented herein are embodiments of systems, processes, methods, etc. The embodiments may relate to a communication device and/or communication system. The communication system can include a Wireless Local Area Network (WLAN) connection. A WLAN connection can include communication and association between two or more stations or wireless devices transmitting wide bandwidth PPDUs. The overall design and functionality of the system described herein is, as one example, a means for selectively utilizing full-duplex communications.

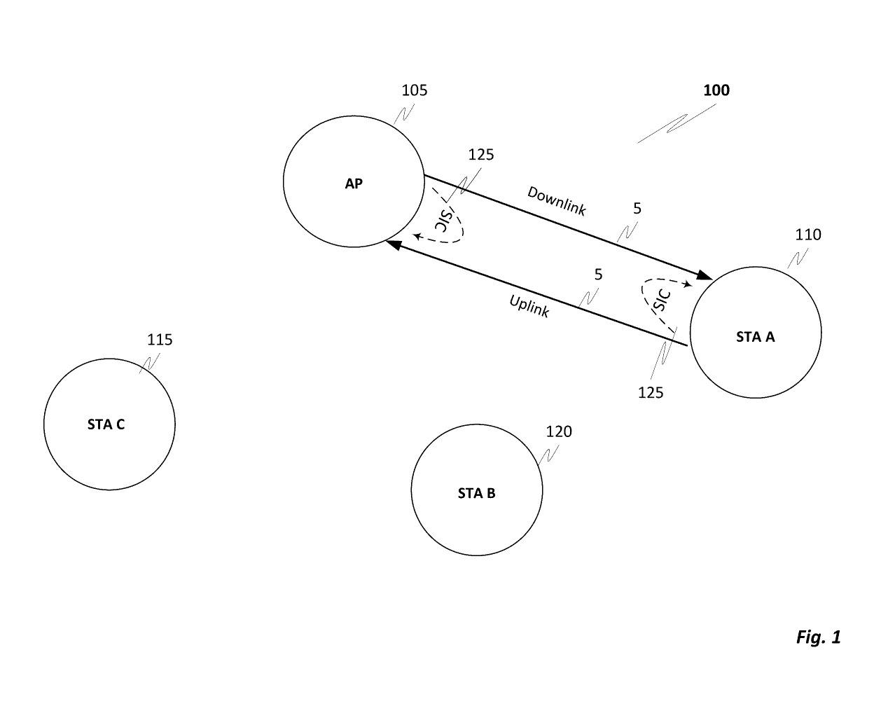

In IEEE 802.11 WLANs, an AP and a STA can use full-duplex capability to simultaneously transmit and receive packets for downlink and uplink traffic, as illustrated in FIG. 1. In particular, FIG. 1 illustrates an exemplary communications environment 100 which includes an AP 105, station A 110, interconnected by downlink 5 and uplink 5, and can optionally include one or more other stations, such as station B 120 and station C 115. As illustrated in the communications environment 100 in FIG. 1, the AP 105 can transmit packets to station A 110, while receiving uplink traffic from station A 110 on the same channel. Both the AP and the STA can completely (or partially) cancel the self-interference caused by their own transmission chain, and successfully decode the received packets. This self-interference cancellation is illustrated as “SIC” 125 in FIG. 1. As a result, this technique of utilizing full-duplex communications can increase the link throughput by up to 2×, in an ideal environment.

However, and as discussed, full-duplex communications may incur some inefficiencies in spectrum use for any number of reasons, including traffic asymmetry (e.g., different data sizes for uplink and downlink transmissions), throughput degradation due to imperfect self-interference cancellation capabilities, and the like. For certain communications scenarios, full-duplex can also be less attractive and even underperform legacy half-duplex communications.

Therefore, full-duplex-capable nodes, such as IEEE 802.11 APs and STAs, can evaluate performance trade-offs between full-duplex and half-duplex operation and dynamically switch between full-duplex and half-duplex modes, instead of statically using full-duplex (or half-duplex) all the time.

In general, one exemplary embodiment allows an IEEE 802.11 station to participate in full-duplex communications only when full-duplex is expected to outperform half-duplex communications. For this, when an AP captures the channel for downlink transmission, the AP can send relevant information to the station inside a FD-RTS (Full-Duplex Request-to-Send) frame. The station can then decide whether full-duplex makes more sense, in terms of performance/efficiency, than half-duplex communications.

If the station makes the determination that half-duplex would outperform full-duplex, the station can indicate so in, for example, a FD-CTS (Full-Duplex Clear-to-Send) message in response to the FD-RTS. By doing this, the access point and the station can better utilize their full-duplex capability and enjoy the performance benefit from full-duplex when appropriate, resulting in an overall higher performance than just using full-duplex or half-duplex blindly.

An exemplary embodiment presents a technique that is different from the existing full-duplex MAC design, in which full-duplex is always turned on regardless of any actual performance benefit. In reality, full-duplex may underperform conventional half-duplex communications due to multiple reasons, including one or more of imperfect self-interference cancellation capabilities, a large separation between the nodes (e.g., AP-STA), and the like.

One exemplary embodiment allows full-duplex capable nodes, such as IEEE 802.11 stations, to selectively participate in full-duplex link setup and transmissions so that the station can dynamically switch between full-duplex and half-duplex, whichever provides better performance.

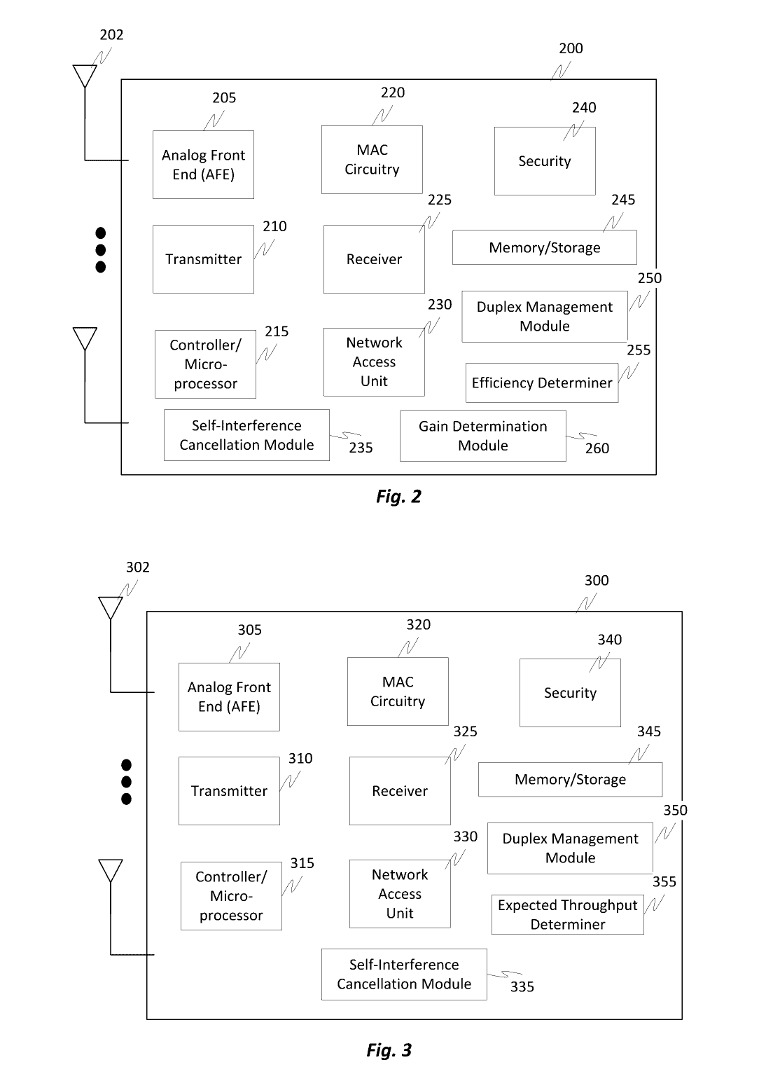

Examples of the componentry in the APs and STAs are shown in FIGS. 2-3. An example of a station (STA) 104 architecture is shown in FIG. 2. The STA 200 may comprise hardware circuitry and/or software that conduct various operations. The STA 200 also includes conventional and well known components which have been omitted for clarity. The operations can include, but are not limited to, conducting calls, synchronizing with other APs, opening multiple applications, presenting information through audio and/or video means, communicating via a WLAN, etc. The STA 200 can be any type of computing system operable to conduct the operations described here. As an example, the STA 200 can be a mobile phone, e.g., smartphone, which includes and interacts with various modules and components as shown in FIG. 2.

The STA 200 can have one more antennas 202, for use in wireless communications such as WLAN, multi-input multi-output (MIMO) communications, Bluetooth®, etc. The antennas 202 can include, but are not limited to directional antennas, omnidirectional antennas, monopoles, patch antennas, loop antennas, microstrip antennas, dipoles, and any other suitable for communication transmission. In an exemplary embodiment, transmission using MIMO may require particular antenna spacing. In another exemplary embodiment, MIMO transmission can enable spatial diversity allowing for different channel characteristics at each of the antennas. In yet another embodiment, MIMO transmission can be used to distribute resources to multiple users. The antennas at the STA and/or AP could also be a special type of antenna 202/302, e.g., a co-located dual-polarized antenna, that provides good isolation between transmission and reception to help mitigate the self-interference at the receiving chain.

Antennas 202 generally interact with an Analog Front End (AFE) module 205, which is needed to enable the correct processing of the received modulated signal and signal conditioning for a transmitted signal. The AFE 412 can be functionally located between the antenna and a digital baseband system in order to convert the analog signal into a digital signal for processing and vice-versa.

The STA 200 can also include a controller/microprocessor 215 and a memory/storage 245. The STA 200 can interact with the memory/storage 245 which may store information and operations necessary for configuring and transmitting or receiving the messages/information described herein. The memory/storage 245 may also be used in connection with the execution of application programming or instructions by the controller/microprocessor 215, and for temporary or long term storage of program instructions and/or data. As examples, the memory/storage 245 may comprise a computer-readable device, RAM, ROM, DRAM, SDRAM or other storage devices and media.

The controller/microprocessor 215 may comprise a general purpose programmable processor or controller for executing application programming or instructions related to the STA 200. Further, controller/microprocessor 215 can perform operations for configuring and transmitting messages/information as described herein. The controller/microprocessor 215 may include multiple processor cores, and/or implement multiple virtual processors. Optionally, the controller/microprocessor 215 may include multiple physical processors. By way of example, the controller/microprocessor 215 may comprise a specially configured Application Specific Integrated Circuit (ASIC) or other integrated circuit, a digital signal processor, a controller, a hardwired electronic or logic circuit, a programmable logic device or gate array, a special purpose computer, or the like.

The STA 200 can further include a transmitter 210 and receiver 225 which can transmit and receive signals, respectively, to and from other STAs or access points using the one or more antennas 202 and AFE 205. Included in the STA 200 circuitry is the medium access control or MAC/NAV (Media Access Control/Network Allocation Vector) circuitry 220. MAC/NAV circuitry 220 provides the medium for controlling access to the wireless medium. In an exemplary embodiment, the MAC/NAV circuitry 220 may be arranged to contend for a wireless medium and configure frames, packets, messages and/or information for communicating over the wireless medium.

The self-interference cancellation module 235 can work or independently of the MAC/NAV circuitry 220. The STA 200 in conjunction with the self-interference cancellation module 235 can cancel in-band (co-channel) self-interference in order to enable full-duplex communications. The self-interference cancellation module 235 can also work with or independently of the Memory/Storage 245 and Controller/Microprocessor 215 in cancelling and/or reducing in-band self-interference.

The STA 200 can also contain a security module 240. This security module 240 can contain information regarding, but not limited to, security parameters required to connect the STA 200 to an AP or other available networks or network devices, and can include WEP or WPA/WPA-2 (optionally+AES and/or TKIP) security access keys, network keys, etc. A WEP security access key is a security password used by Wi-Fi networks. Knowledge of this code will enable the STA 200 to exchange information with an access point. The information exchange can occur through encoded messages with the WEP access code often being chosen by the network administrator. WPA is an added security standard that is also used in conjunction with network connectivity with stronger encryption than WEP.

Another module that the STA 200 can include is the network access unit 230. The network access unit 230 can be used for connecting with the AP. In one exemplary embodiment, connectivity can include synchronization between devices. In another exemplary embodiment, the network access unit 230 can work as a medium which provides support for communication with other stations. In yet another embodiment, the network access unit 230 can work in conjunction with at least the MAC/NAV circuitry 220. The network access unit 220 can also work and interact with one or more of the modules/components described herein.

In addition, the STA 200 comprises a duplex management module 250 and an efficiency determiner 255 that operate to determine whether full- or half-duplex communication protocols should be used as discussed hereinafter and a gain determination module 260.

An example of an access point (AP) 300 architecture is shown in FIG. 3. The AP 300 may comprise hardware circuitry and/or software that conduct various operations. The AP 300 also includes conventional and well known components which have been omitted for clarity. The operations can include, but are not limited to, conducting calls, synchronizing with other APs, opening multiple applications, presenting information through audio and/or video means, communicating via a WLAN, etc. The AP 300 can be any type of computing system operable to conduct the operations described here. As an example, the AP 300 can be a multi-channel, multi-mode access point which includes and interacts with various modules and components as shown in FIG. 3. The (wireless) access point (AP) is a device that can also allow wireless devices to connect to a wired network using Wi-Fi, or related standards. The AP usually connects to a router (via a wired network) as a standalone device, but it can also be an integral component of the router itself. The AP could also be a dual-band, managed or unmanaged, indoor or outdoor access point or bridge.

The AP 300 can have one more antennas 302, for use in wireless communications such as WLAN, multi-input multi-output (MIMO) communications, Bluetooth®, etc. The antennas 302 can include, but are not limited to directional antennas, omnidirectional antennas, monopoles, patch antennas, loop antennas, microstrip antennas, dipoles, and any other suitable for communication transmission. In an exemplary embodiment, transmission using MIMO may require particular antenna spacing. In another exemplary embodiment, MIMO transmission can enable spatial diversity allowing for different channel characteristics at each of the antennas. In yet another embodiment, MIMO transmission can be used to distribute resources to multiple users.

Antennas 302 generally interact with an Analog Front End (AFE) module 305, which is needed to enable the correct processing of the received modulated signal and signal conditioning for a transmitted signal. The AFE 305 can be functionally located between the antenna and a digital baseband system in order to convert the analog signal into a digital signal for processing and vice-versa.

The AP 300 can also include a controller/microprocessor 315 and a memory/storage 345. The AP 300 can interact with the memory/storage 345 which may store information and operations necessary for configuring and transmitting or receiving the messages/information described herein. The memory/storage 345 may also be used in connection with the execution of application programming or instructions by the controller/microprocessor 315, and for temporary or long term storage of program instructions and/or data. As examples, the memory/storage 345 may comprise a computer-readable device, RAM, ROM, DRAM, SDRAM or other storage devices and media.

The controller/microprocessor 315 may comprise a general purpose programmable processor or controller for executing application programming or instructions related to the AP 300. Further, controller/microprocessor 315 can perform operations for configuring and transmitting messages/information as described herein. The controller/microprocessor 315 may include multiple processor cores, and/or implement multiple virtual processors. Optionally, the controller/microprocessor 315 may include multiple physical processors. By way of example, the controller/microprocessor 315 may comprise a specially configured Application Specific Integrated Circuit (ASIC) or other integrated circuit, a digital signal processor, a controller, a hardwired electronic or logic circuit, a programmable logic device or gate array, a special purpose computer, or the like.

The AP 300 can further include a transmitter 310 and receiver 325 which can transmit and receive signals, respectively, to and from STAs or other access points using the one or more antennas 302 and AFE 305. Included in the AP 300 circuitry is the medium access control or MAC/NAV circuitry 320. MAC/NAV circuitry 320 provides the medium for controlling access to the wireless medium. In an exemplary embodiment, the MAC/NAV circuitry 320 may be arranged to contend for a wireless medium and configure frames, packets, messages and/or information for communicating over the wireless medium.

The self-interference cancellation module 335 can work or independently of the MAC/NAV circuitry 320. The AP 300 in conjunction with the self-interference cancellation module 335 can cancel in-band (co-channel) self-interference in order to enable full-duplex communications. The self-interference cancellation module 335 can also work with or independently of the Memory/Storage 345 and Controller/Microprocessor 315 in cancelling and/or reducing in-band self-interference.

The AP 300 can also contain a security module 340. This security module 340 can contain information regarding, but not limited to, security parameters required to connect the AP 300 to another AP or other available networks or network devices, and can include WEP or WPA security access keys, network keys, etc., as discussed.

Another module that the AP 300 can include is the network access unit 330. The network access unit 330 can be used for connecting with another network device. In one exemplary embodiment, connectivity can include synchronization between devices. In another exemplary embodiment, the network access unit 330 can work as a medium which provides support for communication with other stations. In yet another embodiment, the network access unit 330 can work in conjunction with at least the MAC/NAV circuitry 320. The network access unit 320 can also work and interact with one or more of the modules/components described herein.

In addition, the AP 300 comprises a duplex management module 350, and an expected throughput determiner 355 (which can optionally also be included in the STA) that operate to determine whether full- or half-duplex communication protocols should be used as discussed hereinafter.

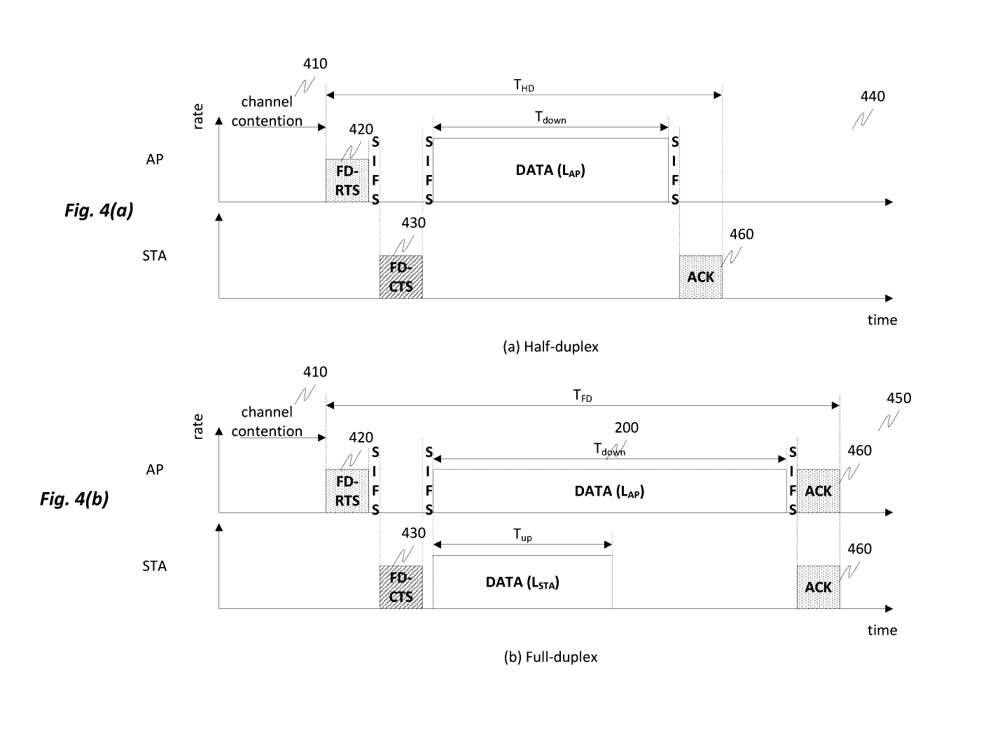

As illustrated in FIG. 4, a proposed channel access mechanism for full-duplex and half-duplex operations for a two-node scenario, such as between an access point, such as access point 300, and a station, such as station 200, is shown. For example, one exemplary proposed MAC protocol commences with the AP 300 winning the channel after channel contention 410. When the AP 300 wins the channel, the AP 300, in cooperation with the duplex management module 350, controller 315 and memory 345, sends a FD-RTS (full-duplex request-to-send) message 420 to the station, such as station 200. This FD-RTS message 420 is for downlink traffic. The FD-RTS message 420 can contain, for example, one or more of the AP's message length (L_{AP}), transmit power (P_{tx,AP}) and SIC capability (h_{SIC,AP} where 0<h_{SIC,AP}<1)

The FD-RTS message can also contain one or more AP-side requirements for full-duplex communication, such as one or more of minimum message length for uplink transmission (or ratio between downlink and uplink messages), estimated channel gain (i.e., h_{AP→STA}, which will be estimated by the station) and/or received power, the STA's SIC capability, the STA's mobility, and/or the like.

The AP then receives the FD-CTS (Full-Duplex Clear-to-Send) message 430 from a station. The FD-CTS contains, for example, a field that indicates whether the station has data to send to the AP (and/or intends to participate in full-duplex communications).

The AP 300 then starts data transmission, either in half-duplex mode 440 or in full duplex mode 450, in cooperation with the transmitter 310 and analog front end 305, followed by an ACK transmission(s) from the station 460.

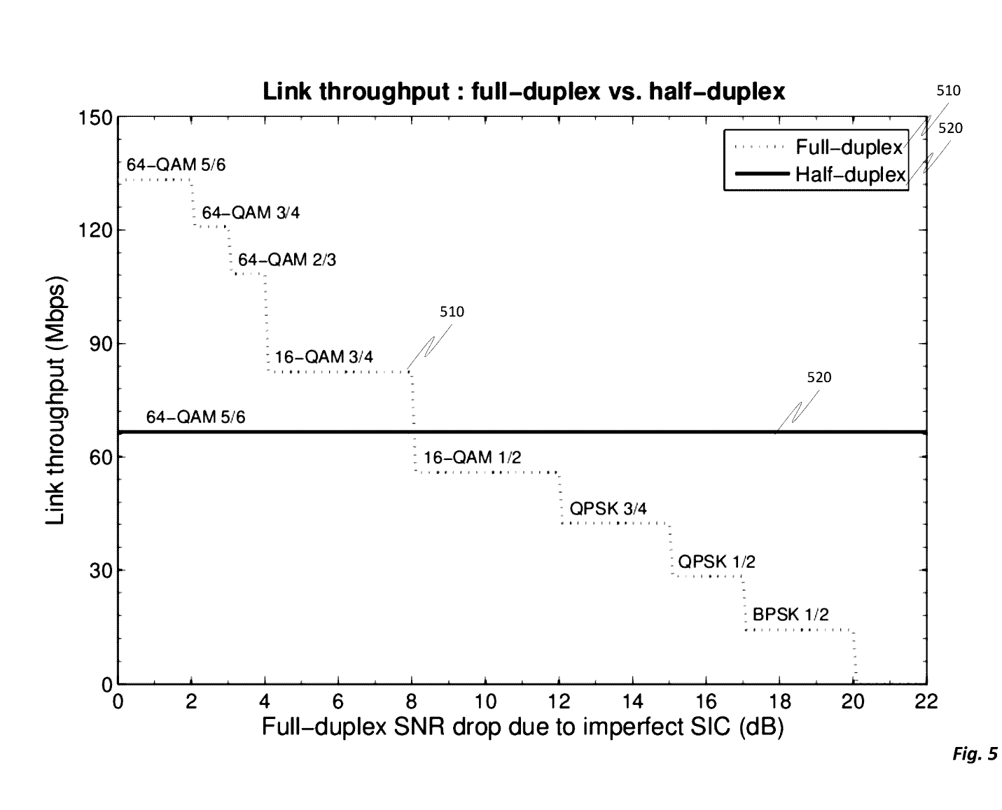

Note that the AP can have a pre-defined set of decision criteria for full-duplex versus half-duplex decisions and embed such information in the FD-RTS message to facilitate the station's decision-making process. As mentioned, the example decision criteria can include one or more of: the ratio of downlink/uplink message, SIC capability at the AP or station, received signal strength, or the like, or a combination of any of the above (See FIG. 5, which shows the impact of imperfect SIC on full-duplex gain).

Other criteria that can be considered by one or more of the station and the access point include one or more of analyzing the number of available channels (in cooperation with the MAC circuitry), and determining whether one or more of the station or access point is mobile (in cooperation with the duplex management module, controller, memory and optionally a location device, such as a global positioning device, or the like). If one or more of the station and access point are mobile, it could optionally be assumed that half-duplex may be better for performance. One or more of the station and access point can then look at mobility as an input parameter and/or performance metric for determining whether to operate in the full-duplex or the half-duplex mode.

More specifically, and in accordance with one exemplary embodiment, upon receipt of the FD-RTS message from the AP 300, the station 200 performs the following steps. In particular, the station 200 first checks whether its uplink transmission, if available, satisfies the AP's full-duplex requirements. This is performed by the duplex management module 250, in cooperation with one or more of the memory 245 and processor 215. If the station's uplink transmission satisfies the requirements from the AP, the station can either (i) further compare the expected throughput, with the cooperation of the efficiency determiner 255, memory 245, and processor 215, between full-duplex and half-duplex, or (ii) decide to participate in full-duplex (to minimize processing overhead).

If the station does not satisfy any of the requirements from the access point, the station will assume full-duplex gains are minimal, and decide to use half-duplex.

When the station does satisfy the requirements, the station, in cooperation with the gain determination module 260, measures the received power, P_{rx,STA}, and calculates the channel gain between the access point and the station, h_{AP→STA}, in accordance with the following equation:

$${h}_{AP \to STA} = \frac{{P}_{rx , STA}}{{P}_{tx , AP}}$$

The STA then calculates the expected throughput from full-duplex (i.e., E[Thruput_{FD}]) and half-duplex (i.e., E[Thruput_{HD}]):
If E[Thruput_{HD}]>E[Thruput_{FD}]
   STA selects the half-duplex mode
If E[Thruput_{FD}]>E[Thruput_{HD}]
   STA selects the full-duplex mode

Upon completion of determining the expected throughput, or if the station did not satisfy any of the requirements from the access point, the station transmits the FD-CTS to the access point. The FD-CTS contains, for example, a field that indicates full-duplex or half-duplex mode, and if full-duplex is chosen, FD-CTS can also contain the station's message length (L_{STA}), transmit power (P_{tx,STA}), and SIC capability (h_{SIC,STA} where 0<h_{SIC,STA}<1).

The station then starts data transmission followed by an ACK transmission from the access point.

Note that while throughput is used as an example performance metric in deciding full-duplex versus half-duplex communications, many other performance metrics such as power, latency, energy consumption, energy availability, power budget, power scheme, remaining battery life, or any combination thereof, can be used as or as part of a decision criteria. For example, a battery-powered station can employ a weighted sum of expected throughput and expected energy consumption as a decision metric.

Exemplary Determination of Expected throughput: Full-duplex vs. Half-duplex

The expected throughput of half-duplex communication can be calculated in accordance with:

$$E [ {Thruput}_{HD} ] = \frac{{L}_{AP}}{{T}_{HD}} = \frac{{L}_{AP}}{{T}_{FD \_ RTS} + {T}_{FD \_ CTS} + E [ {T}_{down} ] + {T}_{ACK} + 3 \times {T}_{SIFS}} , \qquad Eq . ( 1 )$$

where L_{AP} is the message length of the downlink data (i.e., AP→STA). TFD RTS, TFD CTS, and TACK are the transmission time durations for FD-RTS, FD-CTS, and ACK, respectively, T_{SIFS} is the SIFS (Short Inter-Frame Space) time duration and E[T_{down}] is the expected downlink data transmission time.

Similarly, the expected throughput of full-duplex communication can be calculated as:

$$E [ {Thruput}_{FD} ] = \frac{{L}_{AP} + {L}_{STA}}{{T}_{FD}} = \frac{{L}_{AP} + {L}_{STA}}{\begin{matrix}{T}_{FD \_ RTS} + {T}_{FD \_ CTS} + \\ max ( E [ {T}_{down} ] , E [ {T}_{up} ] ) + {T}_{ACK} + 3 \times {T}_{SIFS}\end{matrix}} , \qquad Eq . ( 2 )$$

where L_{STA} is the message length for uplink transmission (i.e., STA→AP), and E[T_{down}] and E[Tᵤₚ] are the expected downlink and uplink data transmission times.

Note that the downlink transmission time with full-duplex communication may be longer than the downlink transmission time with half-duplex communication due to imperfect SIC at the access point. The same applies to the uplink transmission. Therefore, the downlink/uplink transmission time may increase significantly for full-duplex communication depending on the access point/station's SIC capability.

FIG. 5 compares the achieved link-level throughput from full-duplex 510 and half-duplex 520 communications with imperfect SIC capability at the receivers (i.e., AP and STA) for the two-node topology, as shown in FIG. 1. FIG. 5 illustrates that with perfect SIC (i.e., zero dB drop), full-duplex almost doubles the link throughput (e.g., 14 Mbps versus 28 Mbps).

However, as the receiver-side SNR drops due to imperfect SIC capability, the relative throughput gains from full-duplex communications diminish because full-duplex transmitters have to lower their MCS (or rate) to combat residual self-interference. FIG. 5 illustrates that full-duplex even underperforms half-duplex as the SNR drops due to the SIC growing larger than a certain threshold. This clearly indicates that full-duplex may not always outperform half-duplex and should be employed only when full-duplex is expected to outperform half-duplex communication.

In FIG. 5, it was assumed that the receiver power at the AP and STA (when there is no self-interference) is −62 dBm, which allows the access point and the station to use 64-QAM 5/6 (72.2 Mbps with SGI). It was also assumed that a jumbo frame of 9,000 bytes for both downlink and uplink transmission was used. If there is a frame size mismatch in downlink/uplink transmission, the full-duplex performance benefit decreases and hence the performance crossing point in FIG. 5 will shift to the left. This makes the frame size another important consideration in full- vs. half-duplex communication determinations.

FIG. 5 is a flowchart outlining an exemplary method for determining whether to utilize full-duplex or half-duplex communications. Note that the station can make full-duplex or half-duplex decisions by checking the requirements from the access point, and the expected throughput calculation and comparison at the station can be optional and can be done only when the station has enough processing power.

Moreover, while the exemplary embodiment will be described in relation to the AP and station performing certain tasks, it is to be appreciated that any or all of these tasks could be completed by the other of the AP or STA, or performed by different one(s) of the STA or AP.

In accordance with one example, the station can make the determination and share the optimization information with the access point. This could be especially advantageous where the station has sufficient processing power.

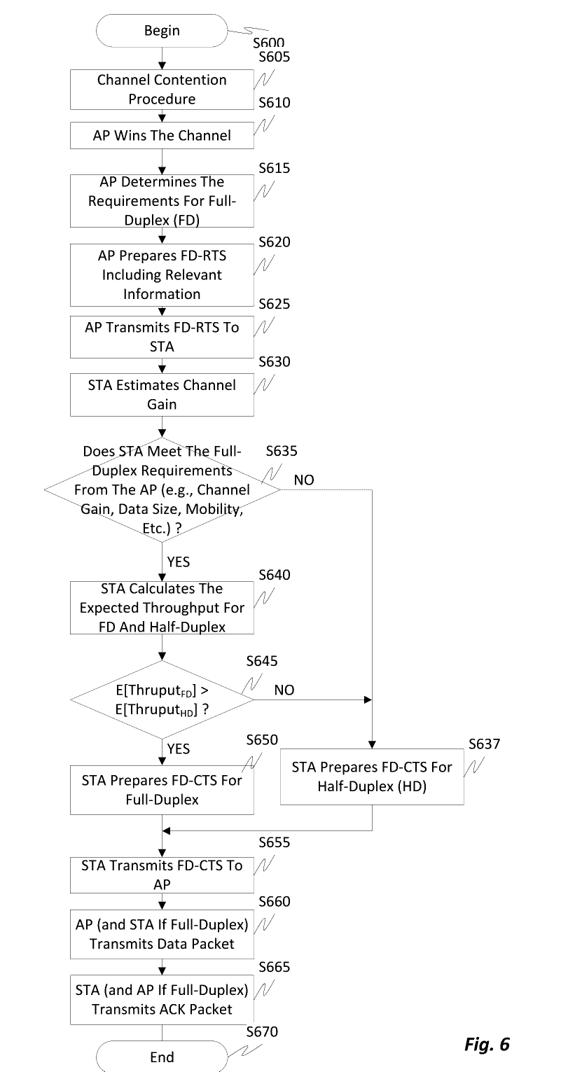

FIG. 6 outlines an exemplary method for assessing whether to utilize full-duplex or half-duplex communications. Control begins in step S600 and continues to step S605. In step S605, the AP performs channel contention. Next, in step S610, the AP wins the channel. Then, in step S615 the AP determines the requirements for full-duplex communications. Control ten continues to step S620.

In step S620, the AP prepares an FD-RTS message that includes the relevant information outlined above. Next, in step S625, the AP transmits this FD-RTS message to the station (STA). Then, in step S630, the station estimates channel gain. Control then continues to step S635.

In step S635 a determination is made whether the station meets the full-duplex requirements from the AP, such as channel gain, data size, mobility, etc. If the station does not meet the full-duplex requirements, control jumps to step S637 with control otherwise continuing to step S640.

In step S637, the station prepares the FD-CTS for half-duplex. Control then continues to step S655.

In step S640, the station determines the expected throughput for full-duplex and half-duplex. Next, in step S645, a determination is made whether the expected throughput for full-duplex is greater than the expected throughput for half-duplex. When the expected throughput for full-duplex is greater than the expected throughput for half-duplex, control continues to step S650. Otherwise, when the expected throughput for full-duplex is less than the expected throughput for half-duplex, control jumps to step S637.

In step S650, the station prepares a FD-CTS message for full-duplex communications. Next, in step S655, the station transmits a FD-CTS message to the access point. Then, in step S660, the access point, and the station if full-duplex mode is entered, transmit data. Control then continues to step S665.

In step S655, the station, and the access point if full-duplex mode is entered, transmit respective ACK packets. Control then continues to step S670 where the control sequence ends.

While the techniques discussed herein have been specifically discussed in relation to IEEE 802.11 systems, it should be appreciated that the techniques discussed herein can generally be applicable to any type of wireless communication standard, protocol, and/or equipment. Moreover, all the flowcharts have been discussed in relation to a set of exemplary steps, it should be appreciated that some of these steps could be optional and excluded from the operational flow without affecting the success of the technique. Additionally, steps provided in the various flowcharts illustrated herein can be used with other techniques illustrated herein.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments have been described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein.

Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

It should also be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links (which may not be shown connecting the elements), including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuit, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to 802.11 communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the description omits well-known structures and devices that may be shown in block diagram form or otherwise summarized.

Exemplary aspects are directed toward:

A wireless device, comprising:

a duplex management module coupled to a processor configured to determine full-duplex requirements;

an expected throughput determiner configured to determine an expected throughput for full-duplex and half-duplex communications and to select either full-duplex communications or half-duplex communications based on the determination; and

a receiver configured to receive a message indicating whether full-duplex or half-duplex communications will be utilized.

Any one or more of the above aspects, further comprising one or more of a transmitter, an analog front end, a security module, memory, one or more antennas, MAC circuitry, and a network access unit.

Any one or more of the above aspects, further comprising MAC circuitry configured to contend for a channel.

Any one or more of the above aspects, further comprising a self-interference cancellation module configured to subtract out transmission interference created to a receiver chain on the same channel.

Any one or more of the above aspects, further comprising a transmitter configured to transmit a full-duplex request to send message to a station.

Any one or more of the above aspects, wherein the station includes a duplex management module configured to determine whether the station meets the full-duplex requirements sent in the full-duplex request to send message.

Any one or more of the above aspects, wherein the station is further configured to transmit a full-duplex request to send message to the device.

Any one or more of the above aspects, wherein the expected throughput for half-duplex communications is based on one or more of: transmission time durations for FD-RTS, FD-CTS, and ACK, respectively, a Short Inter-Frame Space time duration and an expected downlink data transmission time.

Any one or more of the above aspects, wherein the expected throughput for full-duplex communications is based on one or more of: transmission time durations for FD-RTS, FD-CTS, and ACK, respectively, a Short Inter-Frame Space time duration and expected downlink and uplink data transmission times.

Any one or more of the above aspects, wherein the full-duplex requirements include one or more of an access point message length, transmit power and self-interference cancellation.

A method of operating a wireless device, comprising:
determining full-duplex requirements;

determining an expected throughput for full-duplex and half-duplex communications and to select either full-duplex communications or half-duplex communications based on the determination; and

receiving, by a receiver, a message indicating whether full-duplex or half-duplex communications will be utilized.

Any one or more of the above aspects, wherein the wireless device includes one or more of a transmitter, an analog front end, a security module, memory, one or more antennas, MAC circuitry, and a network access unit.

Any one or more of the above aspects, further comprising contending for a channel.

Any one or more of the above aspects, further comprising subtracting out transmission interference created to a receiver chain on the same channel.

Any one or more of the above aspects, further comprising transmitting a full-duplex request to send message to a station.

Any one or more of the above aspects, wherein the station includes a duplex management module configured to determine whether the station meets the full-duplex requirements sent in the full-duplex request to send message.

Any one or more of the above aspects, wherein the station is further configured to transmit a full-duplex request to send message to the device.

Any one or more of the above aspects, wherein the expected throughput for half-duplex communications is based on one or more of: transmission time durations for FD-RTS, FD-CTS, and ACK, respectively, a Short Inter-Frame Space time duration and an expected downlink data transmission time.

Any one or more of the above aspects, wherein the expected throughput for full-duplex communications is based on one or more of: transmission time durations for FD-RTS, FD-CTS, and ACK, respectively, a Short Inter-Frame Space time duration and expected downlink and uplink data transmission times.

Any one or more of the above aspects, wherein the full-duplex requirements include one or more of an access point message length, transmit power and self-interference cancellation.

A wireless device, comprising:
means for determining full-duplex requirements;

means for determining an expected throughput for full-duplex and half-duplex communications and to select either full-duplex communications or half-duplex communications based on the determination; and

means for receiving, by a receiver, a message indicating whether full-duplex or half-duplex communications will be utilized.

Any one or more of the above aspects, wherein the wireless device includes one or more of a transmitter, an analog front end, a security module, memory, one or more antennas, MAC circuitry, and a network access unit.

Any one or more of the above aspects, further comprising means for contending for a channel.

Any one or more of the above aspects, further comprising means for subtracting out transmission interference created to a receiver chain on the same channel.

Any one or more of the above aspects, further comprising means for transmitting a full-duplex request to send message to a station.

Any one or more of the above aspects, wherein the station includes a duplex management module configured to determine whether the station meets the full-duplex requirements sent in the full-duplex request to send message.

Any one or more of the above aspects, wherein the station is further configured to transmit a full-duplex request to send message to the device.

Any one or more of the above aspects, wherein the expected throughput for half-duplex communications is based on one or more of: transmission time durations for FD-RTS, FD-CTS, and ACK, respectively, a Short Inter-Frame Space time duration and an expected downlink data transmission time.

Any one or more of the above aspects, wherein the expected throughput for full-duplex communications is based on one or more of: transmission time durations for FD-RTS, FD-CTS, and ACK, respectively, a Short Inter-Frame Space time duration and expected downlink and uplink data transmission times.

Any one or more of the above aspects, wherein the full-duplex requirements include one or more of an access point message length, transmit power and self-interference cancellation.

A non-transitory computer-readable information storage media, having stored thereon instructions, that when executed by a processor, perform a method for operating a wireless device, comprising:
determining full-duplex requirements;

determining an expected throughput for full-duplex and half-duplex communications and to select either full-duplex communications or half-duplex communications based on the determination; and

receiving, by a receiver, a message indicating whether full-duplex or half-duplex communications will be utilized.

Any one or more of the above aspects, wherein the wireless device includes one or more of a transmitter, an analog front end, a security module, memory, one or more antennas, MAC circuitry, and a network access unit.

Any one or more of the above aspects, further comprising contending for a channel.

Any one or more of the above aspects, further comprising subtracting out transmission interference created to a receiver chain on the same channel.

Any one or more of the above aspects, further comprising transmitting a full-duplex request to send message to a station.

Any one or more of the above aspects, wherein the station includes a duplex management module configured to determine whether the station meets the full-duplex requirements sent in the full-duplex request to send message.

Any one or more of the above aspects, wherein the station is further configured to transmit a full-duplex request to send message to the device.

Any one or more of the above aspects, wherein the expected throughput for half-duplex communications is based on one or more of: transmission time durations for FD-RTS, FD-CTS, and ACK, respectively, a Short Inter-Frame Space time duration and an expected downlink data transmission time.

Any one or more of the above aspects, wherein the expected throughput for full-duplex communications is based on one or more of: transmission time durations for FD-RTS, FD-CTS, and ACK, respectively, a Short Inter-Frame Space time duration and expected downlink and uplink data transmission times.

Any one or more of the above aspects, wherein the full-duplex requirements include one or more of an access point message length, transmit power and self-interference cancellation.

For purposes of explanation, numerous details are set forth in order to provide a thorough understanding of the present embodiments. It should be appreciated however that the techniques herein may be practiced in a variety of ways beyond the specific details set forth herein.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, WiFi, LTE, 4G, Bluetooth®, WirelessHD, WiGig, WiGi, 3GPP, Wireless LAN, WiMAX, and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

Various embodiments may also or alternatively be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

Provided herein are exemplary systems and methods for full- or half-duplex communications in a wireless device(s). While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless device, comprising:
a duplex management module coupled to a processor configured to determine full-duplex requirements;
an expected throughput determiner configured to determine an expected throughput for full-duplex and half-duplex communications and to select either full-duplex communications or half-duplex communications based on the determination; and
a receiver configured to receive a message indicating whether full-duplex or half-duplex communications will be utilized.

2. The device of claim 1, further comprising one or more of a transmitter, an analog front end, a security module, memory, one or more antennas, MAC circuitry, and a network access unit.

3. The device of claim 1, further comprising MAC circuitry configured to contend for a channel.

4. The device of claim 1, further comprising a self-interference cancellation module configured to subtract out transmission interference created to a receiver chain on the same channel.

5. The device of claim 1, further comprising a transmitter configured to transmit a full-duplex request to send message to a station.

6. The device of claim 5, wherein the station includes a duplex management module configured to determine whether the station meets the full-duplex requirements sent in the full-duplex request to send message.

7. The device of claim 5, wherein the station is further configured to transmit a full-duplex request to send message to the device.

8. The device of claim 1, wherein the expected throughput for half-duplex communications is based on one or more of: transmission time durations for FD-RTS, FD-CTS, and ACK, respectively, a Short Inter-Frame Space time duration and an expected downlink data transmission time.

9. The device of claim 1, wherein the expected throughput for full-duplex communications is based on one or more of: transmission time durations for FD-RTS, FD-CTS, and ACK, respectively, a Short Inter-Frame Space time duration and expected downlink and uplink data transmission times.

10. The device of claim 1, wherein the full-duplex requirements include one or more of an access point message length, transmit power and self-interference cancellation.

11. A method of operating a wireless device, comprising:
determining full-duplex requirements;
determining an expected throughput for full-duplex and half-duplex communications and to select either full-duplex communications or half-duplex communications based on the determination; and
receiving, by a receiver, a message indicating whether full-duplex or half-duplex communications will be utilized.

12. The method of claim 11, wherein the wireless device includes one or more of a transmitter, an analog front end, a security module, memory, one or more antennas, MAC circuitry, and a network access unit.

13. The method of claim 11, further comprising contending for a channel.

14. The method of claim 11, further comprising subtracting out transmission interference created to a receiver chain on the same channel.

15. The method of claim 11, further comprising transmitting a full-duplex request to send message to a station.

16. The method of claim 15, wherein the station includes a duplex management module configured to determine whether the station meets the full-duplex requirements sent in the full-duplex request to send message.

17. The method of claim 15, wherein the station is further configured to transmit a full-duplex request to send message to the device.

18. The method of claim 11, wherein the expected throughput for half-duplex communications is based on one or more of: transmission time durations for FD-RTS, FD-CTS, and ACK, respectively, a Short Inter-Frame Space time duration and an expected downlink data transmission time.

19. The method of claim 11, wherein the expected throughput for full-duplex communications is based on one or more of: transmission time durations for FD-RTS, FD-CTS, and ACK, respectively, a Short Inter-Frame Space time duration and expected downlink and uplink data transmission times.

20. The method of claim 11, wherein the full-duplex requirements include one or more of an access point message length, transmit power and self-interference cancellation.

21. A non-transitory computer-readable information storage media, having stored thereon instructions, that when executed by a processor, perform a method for operating a wireless device, comprising:
determining full-duplex requirements;
determining an expected throughput for full-duplex and half-duplex communications and to select either full-duplex communications or half-duplex communications based on the determination; and
receiving, by a receiver, a message indicating whether full-duplex or half-duplex communications will be utilized.
